(19) United States
(12) Patent Application Publication
(10) Pub. No.: US 2025/0119087 A1
(43) Pub. Date: Apr. 10, 2025

(54) ELECTRIC VEHICLE PROPULSION AND CHARGING SYSTEM

(71) Applicant: GM GLOBAL TECHNOLOGY OPERATIONS LLC, Detroit, MI (US)

(72) Inventors: Junghoon Kim, Springboro, OH (US); Chandra S. Namuduri, Troy, MI (US); Khorshed Mohammed Alam, Canton, MI (US); Rashmi Prasad, Troy, MI (US); Yilun Luo, Ann Arbor, MI (US)

(73) Assignee: GM GLOBAL TECHNOLOGY OPERATIONS LLC, Detroit, MI (US)

(21) Appl. No.: 18/481,447

(22) Filed: Oct. 5, 2023

(51) Int. Cl. H02P 27/06; B60L 50/51; B60L 50/60; B60L 53/20; H02J 7/00; H02P 25/22

(52) U.S. Cl. CPC H02P 27/06; B60L 50/51; B60L 50/60; B60L 53/20; H02J 7/007; H02P 25/22; B60L 2210/42; H02J 2207/20

(57) ABSTRACT

A motor vehicle includes an AC (alternating current) electric motor having a stator with a plurality of stator windings, a rechargeable source of stored electrical energy, and an inverter coupled to the rechargeable source of stored electrical energy and to the AC electric motor. The system also includes one or more controllers collectively programmed to switch the inverter to provide alternating current propulsive energy from the rechargeable source of stored electrical energy to the plurality of stator windings and, using at least one of the stator windings as a boost inductor, switch the inverter to step up a voltage at a charging input coupled to the inverter to charge the rechargeable source of stored electrical energy.

### INTRODUCTION

The present disclosure is in the field of electric vehicle propulsion and charging.

In an electric vehicle, a source of electrical energy such as one or more traction batteries may provide energy for propulsion of the electric vehicle. Traction batteries of electric vehicles require recharging. A traction battery of a newer electric vehicle may have a nominal voltage that is higher than the output voltage of legacy battery chargers that are installed in the field. Accordingly, a system that can facilitate charging of an electric vehicle's traction batteries with a battery charger having a lower output voltage than the traction batteries' nominal voltage may be advantageous.

### SUMMARY

A motor vehicle includes an AC (alternating current) electric motor having a stator with a plurality of stator windings, a rechargeable source of stored electrical energy, and an inverter coupled to the rechargeable source of stored electrical energy and to the AC electric motor. The motor vehicle also includes one or more controllers collectively programmed to switch the inverter to provide alternating current propulsive energy from the rechargeable source of stored electrical energy to the plurality of stator windings and, using at least one of the stator windings as a boost inductor, switch the inverter to step up a voltage at a charging input coupled to the inverter to charge the rechargeable source of stored electrical energy. The rechargeable source of stored electrical energy may include a battery. Further, the inverter may be an inverter with greater than two output voltage levels. Further yet, the inverter may be a two-level inverter. Additionally, the AC electric motor may be a six-phase AC electric motor.

The plurality of stator windings may include a first set of WYE-connected three-phase stator windings and a second set of WYE-connected three-phase stator windings, the first set of WYE-connected three-phase stator windings having a first neutral point and the second set of WYE-connected three-phase stator windings having a second neutral point. The AC electric motor may include a switchable contact interposed between the first neutral point and the second neutral point. Additionally, the one or more controllers may further be collectively programmed to cause the switchable contact to be open while the inverter is switched to provide alternating current propulsive energy from the rechargeable source of stored electrical energy to the plurality of stator windings, and to cause the switchable contact to be closed while the inverter is switched to step up a voltage at a charging input coupled to the inverter to charge the rechargeable source of stored electrical energy.

In the motor vehicle, the charger may be switchably coupled to the inverter by a switchable contact. Additionally, the one or more controllers may be further collectively programmed with an instruction to cause the switchable contact to be closed while the inverter is switched to step up a voltage at the charging input to charge the rechargeable source of stored electrical energy.

Additionally, the instruction to switch the inverter to step up a voltage from the charging input to charge the rechargeable source of electrical energy further may further include an instruction to perform two-phase interleaved step-up conversion.

A method for controlling an electric vehicle propulsion and charging system includes switching an inverter to provide alternating current propulsive energy from a rechargeable source of stored electrical energy to a plurality of stator windings of an AC electric motor and, using at least one of the stator windings as a boost inductor, switching the inverter to step up a voltage from a charging input coupled to the inverter to charge the rechargeable source of stored electrical energy. The rechargeable source of stored electrical energy may include a battery. Further, the inverter may be an inverter with greater than two output voltage levels. Further yet, the inverter may be a two-level inverter. Additionally still, the AC electric motor may be a six-phase AC electric motor. In addition, switching the inverter to upconvert a voltage from the charging input to charge the rechargeable source of stored electrical energy may include performing two-phase interleaved step-up conversion.

The plurality of stator windings may include a first set of WYE-connected three-phase stator windings and a second set of WYE-connected three-phase stator windings, the first set of WYE-connected three-phase stator windings having a first neutral point and the second set of WYE-connected three-phase stator windings having a second neutral point. The electric vehicle propulsion and charging system may further include a switchable contact interposed between the first neutral point and the second neutral point. The method may additionally include causing the switchable contact to be open while the inverter is switched to provide alternating current propulsive energy from the rechargeable source of stored electrical energy the plurality of stator windings, and causing the switchable contact to be closed while the inverter is switched to upconvert a voltage from the charging input to charge the rechargeable source of stored electrical energy. The battery charger may be switchably coupled to the inverter by a switchable contact. Further, the method may include causing the switchable contact to be closed while the inverter is switched to upconvert a voltage from the charging input to charge the rechargeable source of stored electrical energy.

A second motor vehicle includes an AC electric motor having a stator with a plurality of stator windings, the plurality of stator windings including a first set of WYE-connected three-phase stator windings having a first neutral point and a second set of WYE-connected three-phase stator windings having a second neutral point, the AC electric motor additionally including a switchable contact interposed between the first neutral point and the second neutral point. The second motor vehicle additionally includes a rechargeable source of stored electrical energy and an inverter coupled to the rechargeable source of stored electrical energy and to the AC electric motor. Further, the second motor vehicle includes one or more controllers collectively programmed with the following instructions: cause the switchable contact to be open and switch the inverter to provide alternating current propulsive energy from the rechargeable source of stored electrical energy to the plurality of stator windings; and cause the switchable contact to be closed and, using at least one of the stator windings as a boost inductor, switch the inverter to step up a voltage at a charging input coupled to the inverter to charge the rechargeable source of stored electrical energy.

In the second motor vehicle, the charging input may be switchably coupled to the inverter by a second switchable contact. Additionally, the one or more controllers may be further collectively programmed with the following instruction: cause the second switchable contact to be closed while the inverter is switched to step up a voltage at the charging input to charge the rechargeable source of stored electrical energy. Further yet, the instruction to switch the inverter to step up a voltage at the charging input to charge the rechargeable source of electrical energy may additionally include an instruction to perform two-phase interleaved step-up conversion. The inverter may be a two-level inverter.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 illustrates an electric vehicle containing an electric vehicle propulsion system.

FIG. 2 shows the electric vehicle propulsion system of FIG. 1, along with a charger for charging a traction battery in the electric vehicle.

FIG. 3 illustrates the switching elements in the power inverter module of the electric vehicle propulsion system.

FIG. 4 illustrates the stator windings of an electric motor that may be used in the electric vehicle propulsion system.

FIG. 5 illustrates the mutual winding directions of two of the stator windings.

FIG. 6 illustrates connections between a battery charger and the power inverter module of the electric vehicle propulsion system.

FIG. 7 shows an equivalent circuit for charging the traction battery of the electric vehicle propulsion system with the battery charger.

FIG. 8 illustrates a six-phase electric motor.

FIG. 9 shows an equivalent circuit for charging the traction battery of the electric vehicle propulsion system if the six-phase motor is used in the electric vehicle propulsion system.

FIG. 10 shows two three-phase electric motors.

FIG. 11 illustrates an electric vehicle propulsion system having a two-level power inverter module, with a traction battery and battery charger connected.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

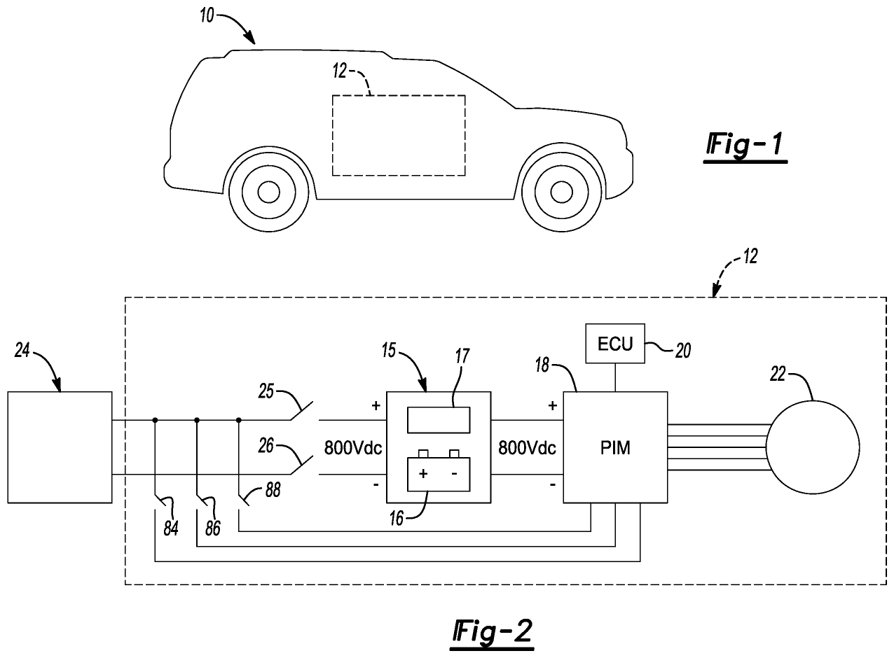

Referring first to FIG. 1, an electric vehicle 10 is illustrated. Electric vehicle 10 may be a vehicle that uses an electric motor for at least part of the vehicle's propulsion and may be a full-electric or hybrid-electric vehicle. Further, electric vehicle 10 may be any style of vehicle, such as a car, truck, sport-utility vehicle (SUV), motorcycle, bicycle, all-terrain vehicle, etc. Electric vehicle 10 includes an electric propulsion system 12.

Referring additionally to FIG. 2, electric propulsion system 12 may include a rechargeable energy storage system (RESS) 15, which may include a rechargeable source of electrical energy such as a traction battery 16 and a battery management system (BMS) 17 used to manage traction battery 16, including the charging thereof. Traction battery 16 may comprise one or more batteries or battery cells. Electric propulsion system 12 may also include a power inverter module (PIM) 18, which may be a voltage inverter, an electronic control unit (ECU) 20 and an electric motor 22. Electric motor 22 may be a motor that provides tractive power for propulsion of electric vehicle 10. Electric motor 22 may be a three-phase AC motor. Electric motor 22 may be, for instance, a permanent magnet motor (and, further, a permanent magnet synchronous motor) or an induction motor.

Charging of traction battery 16 may be via coupling of RESS 15 to a battery charger 24, such as a direct current (DC) charger that may be a DC fast charger. If battery charger 24 has the same nominal voltage output as the nominal voltage of traction battery 16, battery charger 24 may be coupled directly to RESS 15 by the closing of switchable contact 25 and switchable contact 26. As one example of this scenario, traction battery 16 may have a nominal voltage of 800 V, and battery charger 24 may have a nominal output voltage of 800 Vdc.

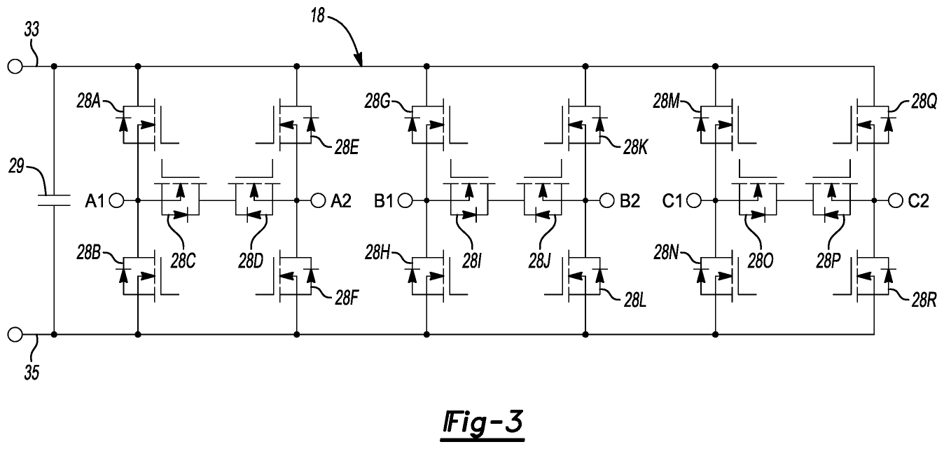

Referring additionally to FIG. 3, power inverter module 18 may include eighteen switching elements, namely, switching element 28A, switching element 28B, switching element 28C, switching element 28D, switching element 28E, switching element 28F, switching element 28G, switching element 28H, switching element 28I, switching element 28J, switching element 28K, switching element 28L, switching element 28M, switching element 28N, switching element 28O, switching element 28P, switching element 28Q, and switching element 28R, which switching elements may also be collectively referred to hereinafter as switching elements 28A-28R. Switching elements 28A-28R may be of various technologies for the purpose of this disclosure, including insulated gate bipolar transistors (IGBTs) and field-effect transistors (FETs). Power inverter module 18 may also include a DC link capacitor 29.

Power inverter module 18 may be a multi-level inverter, namely, in the example of FIG. 3, a three-level inverter, connected across two voltage rails, positive rail 33 and negative rail 35. The voltage between positive rail 33 and negative rail 35, that is, the voltage of traction battery 16, may be 800 volts DC in this example. Power inverter module 18 may have six outputs, output A1, output A2, output B1, output B2, output C1, and output C2, each coupled to electric motor 22. Because power inverter module 18 may be a three-level inverter, each of output A1, output A2, output B1, output B2, output C1 and output C2 may assume one of three voltage states: the voltage of positive rail 33, the voltage of negative rail 35, and a voltage midway between the voltage of positive rail 33 and negative rail 35.

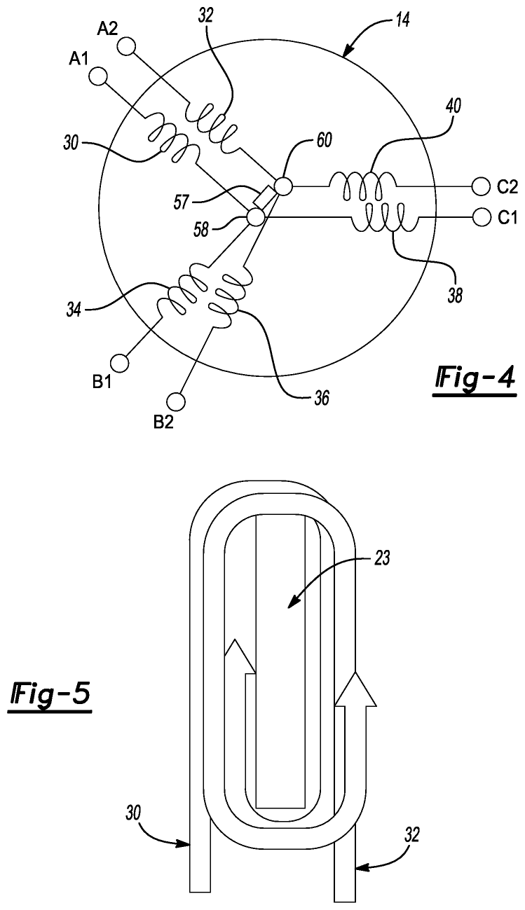

Referring additionally to FIG. 4, electric motor 22 may be a three-phase motor whose stator 14 has three pairs of stator windings, one pair of stator windings for each phase. Accordingly, stator winding 30 and stator winding 32 may be for one phase (called, say, Phase A of electric motor 22). Stator winding 34 and stator winding 36 may be for a Phase B of electric motor 22 and stator winding 38 and stator winding 40 may be for a Phase C of electric motor 22. As illustrated, stator winding 30 may be coupled to output A1 of power inverter module 18, stator winding 32 may be coupled to output A2, stator winding 34 may be coupled to output B1, stator winding 36 may be coupled to output B2, stator winding 38 may be coupled to output C1, and stator winding 40 may be coupled to output C2. Each pair of stator windings of a phase, say stator winding 30 and stator winding 32 of Phase A, may be wound in anti-parallel relative to one another within stator 23 of electric motor 22, as shown in FIG. 5. Stator winding 30, stator winding 34 and stator winding 38 may comprise a set of WYE-connected stator windings with a neutral point 58. Stator winding 32, stator winding 36 and stator winding 40 may comprise a set of WYE-connected stator windings with a neutral point 60. Neutral point 58 and neutral point 60 may be electrically isolated from one another during operation of electric motor 22. Neutral point 58 and neutral point 60 may be connected by a switchable contact 57 of a contactor when traction battery 16 is to be charged by a battery charger 24 whose output is significantly below 800 Vdc, say 400 Vdc. Switchable contact 57 may otherwise be open.

Electronic control unit (ECU) 20 may control the switching of switching elements 28A-28R for the purpose of controlling and providing voltage to electric motor 22. In other words, electronic control unit 20 may switch power inverter module 18 (and/or supervise the switching of power inverter module 18) to provide alternating current (AC) propulsive energy from traction battery 16 to the stator windings of electric motor 22. Electronic control unit 20 is understood to have suitable electronic resources (microprocessor, software, memory, inputs, outputs, and the like) to perform the functions ascribed to electronic control unit 20 herein. Electronic control unit 20 may be a standalone controller, may be integrated with power inverter module 18, or may be integrated with other controllers in the electrical system of electric vehicle 10 that contains propulsion system 12. Electronic control unit 20 may also be networked with other controllers in the electrical system of electric vehicle 10 and share responsibility for performing the functions laid out herein. The controllers described in this disclosure may operate in response to “instructions,” each of which should be understood to comprise one or more software operations; each instruction may further comprise or include other or additional instructions.

Recall that the pair of stator windings for each phase, for instance stator winding 30 and stator winding 32 of phase A, are wound antiparallel relative to one another. However, given the three-level nature of power inverter module 18, stator winding 30 and stator winding 32 may be energized through nodes A1 and A2 with opposite polarities of voltage pulses. As such, the magnetic fields generated by each of stator winding 30 and stator winding 32 will reinforce one another, rather than cancelling one another, due to the antiparallel winding of stator winding 30 and stator winding 32. (The same is true of stator winding 34 and stator winding 36 (phase B), and stator winding 38 and stator winding 40 (phase C.)) Using a multi-level inverter such as power inverter module 18 allows opposite voltage polarities to be provided to the pairs of stator windings in each phase, as a method of cancelling or partially cancelling the dv/dt associated with switching the stator windings and of reducing electrical noise.

In the charging of traction battery 16 of electric vehicle 10, use of a DC fast charger may favorably provide a fast charging process. However, whereas traction battery 16 may be an 800V battery, legacy DC chargers may exist that were designed to charge at significantly less than 800 Vdc, say, at 400 Vdc for example. In order to allow a 400 Vdc charger to charge an 800V battery, power inverter module 18 and the stator windings of electric motor 22 may be used advantageously.

The process for using a 400 Vdc charger to charge an 800 V traction battery may begin with parking electric motor with Phase A of electric motor 22 aligned with the d-axis of electric motor 22. The “d-axis” is the non-torque-producing axis of an AC electric motor, as contrasted with the “q-axis”, in field-oriented control of AC motors. Parking electric motor 22 in this manner reduces the likelihood that passing charge current through Phase A, as will be heretofore described, will tend to unnecessarily generate torque in electric motor 22. In field-oriented control, the rotational position of the rotor of the electric motor under control is sensed or inferred and is therefore known.

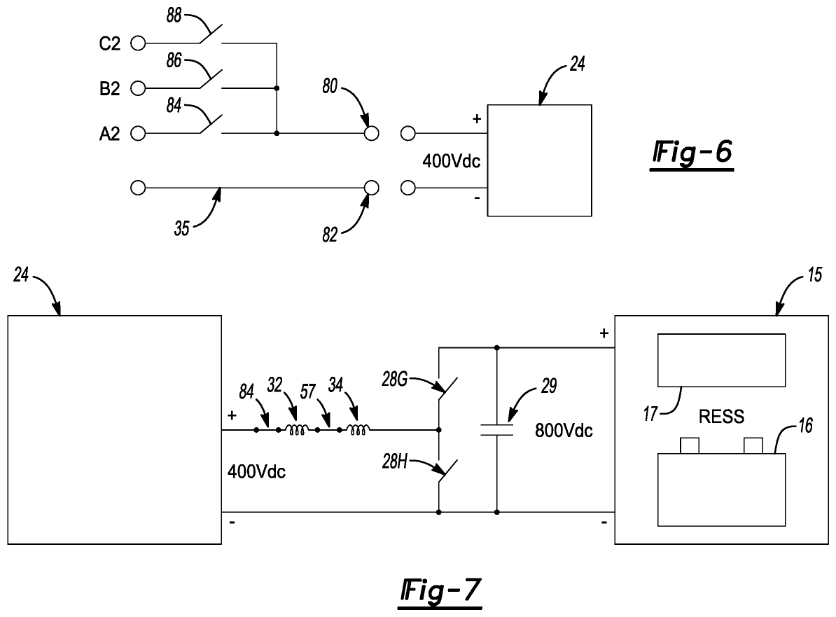

Refer now additionally to FIG. 6. If charging with a battery charger 24 having an output of significantly less than 800 Vdc, say, 400 Vdc, 400 Vdc outputs of battery charger 24 may be connected across charging port 80 and charging port 82 provided in propulsion system 12, coupling charging port 80 (which may be referred to as a charging input) to power inverter module 18. Further, switchable contact 25 (FIG. 2) may be opened. Additionally, a switchable contact 84 may be turned ON (that is, closed), coupling the positive output of battery charger 24 to stator winding 32 of electric motor 22 (one of the stator windings of Phase A of electric motor 22). Further yet, switchable contact 57 (FIG. 4) may be closed to couple neutral point 58 and neutral point 60 of the stator windings of electric motor 22 together. Assume further that all switching elements of Phase A of power inverter module 18 (switching element 28A, switching element 28B, switching element 28C, switching element 28D, switching element 28E and switching element 28F) are held OFF (that is, open). Additionally, assume that switching element 28I, switching element 28J, switching element 28K, and switching element 28L of Phase B of power inverter module 18 are held OFF (that is, open). Finally, assume that all switching elements of Phase C (switching element 28M, switching element 28N, switching element 28O, switching element 28P, switching element 28Q, and switching element 28R) are held OFF (that is, open). An equivalent circuit showing the topology of the boost converter thereby created is shown with reference to FIG. 7. Switching elements 28G and 28H (shown schematically in FIG. 7 as on-off switches) may then work with stator winding 32 and stator winding 34 as an inductive boost voltage converter to convert the 400 Vdc output from battery charger 24 to 800 Vdc for charging traction battery 16. Switching elements 28G and 28H may be pulse-width-modulation (PWM) controlled to carry out the boost conversion, in any of the manners carried out in the art of DC-DC power conversion. The control of the boost conversion may be by electronic control unit 20 or by another electronic controller in the electrical system of electric vehicle 10. Suitable feedback would be provided to the controller that manages the boost conversion. Further, control of switchable contacts 57 and switchable contact 84 may be by electronic control unit 20 or by another electronic controller in the electrical system of electric vehicle 10 that is informed by a suitable signal of the impending 400 Vdc charging.

As thus described, power inverter module 18 is switched to step up (or upconvert, or boost) the voltage from battery charger 24 coupled to power inverter module 18 to charge traction battery 16.

As an alternative, two-phase interleaved control of the voltage boost process may be implemented. Consider the topology of FIG. 7 but, additionally, instead of switching element 28M and switching element 28N being held OFF (that is, open), they may work along with stator winding 38 in order to additionally perform boost conversion. The control of boost conversion comprising switching element 28G, switching element 28H and stator winding 34 may be interleaved with (that is, phase shifted relative to) boost conversion comprising switching element 28M, switching element 28N and stator winding 38. As such, the boost conversion process may be two-phase, with the two phases interleaved, resulting in less voltage ripple at the output of the boost conversion process and higher efficiency.

As an alternative, multiple switchable contacts, switchable contact 84, switchable contact 86, and switchable contact 88 (FIG. 2) may be used. The switchable contact 84, switchable contact 86, or switchable contact 88 that is in the phase that is most closely aligned with the d-axis of electric motor 22 may be closed (that is, ON) with the others of switchable contact 84, switchable contact 86 and switchable contact 88 remaining open (that is, OFF). Voltage boost conversion may then be performed as heretofore described.

Note for additional clarity that switchable contact 25, switchable contact 26, switchable contact 57, switchable contact 84, switchable contact 86, and switchable contact 88 may all be OFF (that is, open) during normal operation of electric motor 22, that is, when electric motor 22 is used in propulsion of electric vehicle 10 using switched alternating current propulsive energy provided by power inverter module 18 from traction battery 16. Switchable contact 25, switchable contact 26, switchable contact 57, switchable contact 84, switchable contact 86, and switchable contact 88 may be controlled by ECU 20, by other controller(s) in the electrical system of electric vehicle 10, or by a combination of controllers in the networked electrical system of electric vehicle 10. The switchable contacts may also be switches that are manually opened and closed or are opened and closed by the physical action, say, of plugging/unplugging propulsion system 12 into a battery charger.

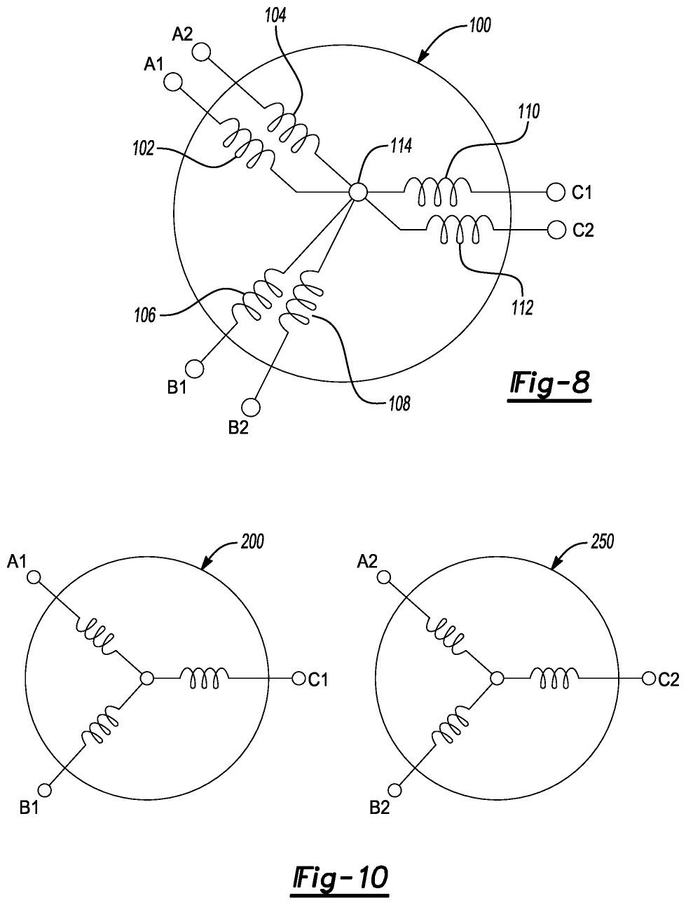

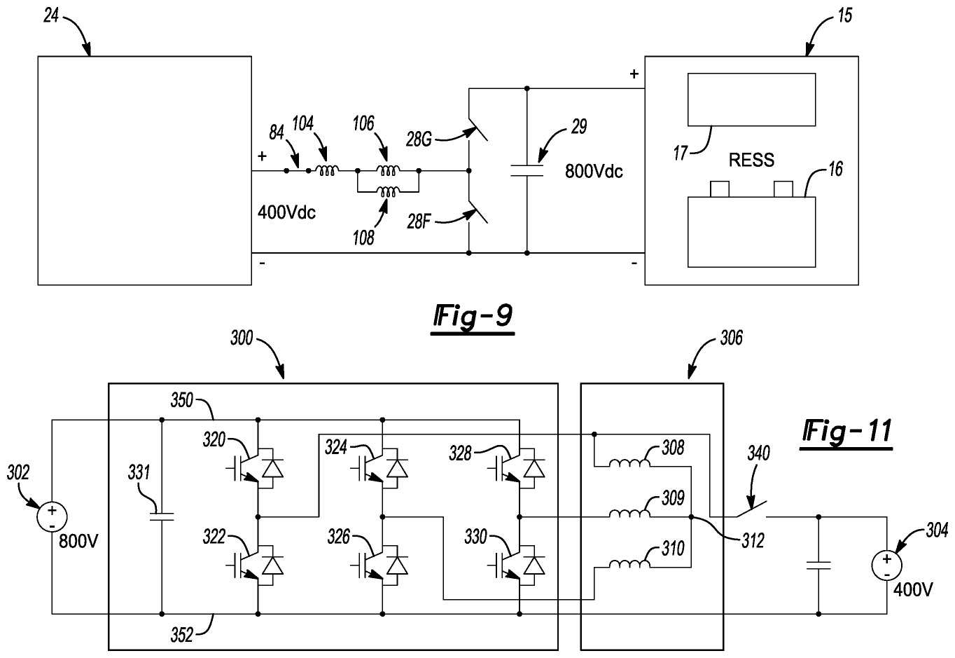

Consider an alternative scenario. Refer additionally to FIG. 8, where a six-phase AC electric motor 100 is shown. Here, all six stator windings, stator winding 102, stator winding 104, stator winding 106, stator winding 108, stator winding 110 and stator winding 112 are coupled to a common neutral point 114 (that is, connected in a WYE configuration) within electric motor 100. If the terminals of electric motor 100 are coupled to corresponding outputs of power inverter module 18, voltage boost conversion may be performed using switching elements 28G and 28H of power inverter module 18. Switching element 28A, switching element 28B, switching element 28C, switching element 28D, switching element 28E, switching element 28F, switching element 28K, switching element 28L, switching element 28M, switching element 28N, switching element 28O, switching element 28P, switching element 28Q, and switching element 28R may be held OFF (that is, open). Further, switching element 28I and switching element 28J may be held ON (that is, closed), effectively paralleling stator winding 106 and stator winding 108. Under the above conditions and with a 400 Vdc output from battery charger 24 coupled across charging port 80 and charging port 82, the equivalent circuit will be as illustrated in FIG. 9. Voltage step up conversion may be performed via PWM control of switching element 28G and switching element 28H.

As an enhancement to the scenario illustrated in FIG. 9, switching element 28O and switching element 28P may be held ON (that is, closed), effectively paralleling stator winding 110 and stator winding 112. Switching element 28M and switching element 28N may be pulse-width-modulation controlled in an interleaved fashion with control of switching element 28E and switching element 28F in order to generate a two-phase interleaved stepped up output to charge traction battery 16.

As an alternative, consider FIG. 10. There, if power inverter module 18 is used to control propulsion of two three-phase electric motors 200 and 250, with the terminals of electric motor 200 and the terminals of electric motor 250 coupled to their corresponding outputs of power inverter module 18, electric motor 200 and electric motor 250 may collectively be used in the voltage boost conversion process, using the principles disclosed herein.

As a further alternative, consider FIG. 11. There, a two-level inverter 300 may provide switched voltage from traction battery 302 for electric motor 306. “Two-level” means that the outputs of inverter 300 may assume one of two voltage values, the voltage of a positive rail 350 (at, say, 800 Vdc in this example) or the voltage of a negative rail 352 at zero volts (that is, −800 Vdc relative to positive rail 350).

The nominal voltage of traction battery 302 may be 800 volts. Traction battery 302 may be contained within a battery management system that supervises charging of traction battery 302. Inverter 300 may contain switching element 320, switching element 322, switching element 324, switching element 326, switching element 328 and switching element 330. Inverter 300 may also include a DC link capacitor 331. Electric motor 306 may be a three-phase AC motor having stator winding 308, stator winding 309 and stator winding 310. The three stator windings may be connected within electric motor 306 at a neutral point 312. A switchable contact 340 may be open under conditions where electric motor 306 is operating to provide tractive power. However, if traction battery 302 is to be charged from a source of energy at a voltage significantly lower than the nominal voltage of traction battery 302, such as battery charger 304 (which may be a 400 Vdc fast charger in this example), switchable contact 340 may be closed. Then, the positive output of battery charger 304 is coupled to stator winding 308. Switching element 324 and switching element 326 may then be PWM controlled to work in concert with stator winding 308 and stator winding 310 in order to provide voltage boost conversion for charging battery 302 at 800 Vdc. Alternatively, switching element 328 and switching element 330 may work in concert with stator winding 309.

Alternatively yet, the control of stator winding 308 and stator winding 309 and stator winding 310 may be performed in an interleaving fashion to provide two-phase voltage boost (or step up conversion, or upconversion) for charging battery 302.

As one alternative, the software in ECU 20 may be capable of being updated by over-the-air (OTA) updating. In that way, ECU 20 may be programmed to perform the voltage upconversion described herein from variable DC charger voltages (other than the 400 Vdc example described herein).

An advantage of the battery charging system and method described herein is that access to the neutral point(s) of the motors is not necessary. That may reduce the likelihood of inducing electrical noise into the system. However, access to the neutral points may, on the other hand, provide additional possible topologies for upconversion for charging traction battery 16 of propulsion system 12 of electric vehicle 10.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A motor vehicle comprising:
an AC (alternating current) electric motor having a stator with a plurality of stator windings;
a rechargeable source of stored electrical energy;
an inverter coupled to the rechargeable source of stored electrical energy and to the AC electric motor;
one or more controllers collectively programmed with the following instructions:
switch the inverter to provide alternating current propulsive energy from the rechargeable source of stored electrical energy to the plurality of stator windings; and
using at least one of the stator windings as a boost inductor, switch the inverter to step up a voltage at a charging input coupled to the inverter to charge the rechargeable source of stored electrical energy.

2. The motor vehicle of claim 1, wherein the rechargeable source of stored electrical energy comprises a battery.

3. The motor vehicle of claim 2, wherein the inverter is an inverter with greater than two output voltage levels.

4. The motor vehicle of claim 2, wherein the inverter is a two-level inverter.

5. The motor vehicle of claim 2, wherein:
the plurality of stator windings comprises a first set of WYE-connected three-phase stator windings and a second set of WYE-connected three-phase stator windings, the first set of WYE-connected three-phase stator windings having a first neutral point and the second set of WYE-connected three-phase stator windings having a second neutral point;
the AC electric motor vehicle further comprises a switchable contact interposed between the first neutral point and the second neutral point; and
the one or more controllers are further collectively programmed with the following instructions:
cause the switchable contact to be open while the inverter is switched to provide alternating current propulsive energy from the rechargeable source of stored electrical energy to the plurality of stator windings; and
cause the switchable contact to be closed while the inverter is switched to step up a voltage at the charging input to charge the rechargeable source of stored electrical energy.

6. The motor vehicle of claim 2, wherein:
the charging input is switchably coupled to the inverter by a switchable contact; and
the one or more controllers are further collectively programmed with the following instruction:
cause the switchable contact to be closed while the inverter is switched to step up a voltage at the charging input to charge the rechargeable source of stored electrical energy.

7. The motor vehicle of claim 2, wherein the AC electric motor is a six-phase AC electric motor.

8. The motor vehicle of claim 2, wherein:
the instruction to switch the inverter to step up a voltage at the charging input to charge the rechargeable source of electrical energy further comprises an instruction to perform two-phase interleaved step-up conversion.

9. A method for controlling an electric vehicle propulsion and charging system, the method comprising:
switching an inverter to provide alternating current propulsive energy from a rechargeable source of stored electrical energy to a plurality of stator windings of an AC (alternating current) electric motor; and
using at least one of the stator windings as a boost inductor, switching the inverter to step up a voltage at a charging input coupled to the inverter to charge the rechargeable source of stored electrical energy.

10. The method of claim 9, wherein the rechargeable source of stored electrical energy comprises a battery.

11. The method of claim 10, wherein the inverter is an inverter with greater than two output voltage levels.

12. The method of claim 10, wherein the inverter is a two-level inverter.

13. The method of claim 10, wherein:
the plurality of stator windings comprises a first set of WYE-connected three-phase stator windings and a second set of WYE-connected three-phase stator windings, the first set of WYE-connected three-phase stator windings having a first neutral point and the second set of WYE-connected three-phase stator windings having a second neutral point;
the electric vehicle propulsion and charging system further comprises a switchable contact interposed between the first neutral point and the second neutral point;
the method further comprises causing the switchable contact to be open while the inverter is switched to provide alternating current propulsive energy from the rechargeable source of stored electrical energy to the plurality of stator windings; and
the method further comprises causing the switchable contact to be closed while the inverter is switched to step up a voltage at the charging input to charge the rechargeable source of stored electrical energy.

14. The method of claim 10, wherein:
the charging input is switchably coupled to the inverter by a switchable contact; and
wherein the method further comprises causing the switchable contact to be closed while the inverter is switched to step up a voltage at the charging input to charge the rechargeable source of stored electrical energy.

15. The method of claim 10, wherein the AC electric motor is a six-phase AC electric motor.

16. The method of claim 10, wherein:
switching the inverter to step up a voltage at the charging input to charge the rechargeable source of stored electrical energy comprises performing two-phase interleaved step-up conversion.

17. A motor vehicle comprising:
an AC (alternating current) electric motor having a stator with a plurality of stator windings, the plurality of stator windings comprising a first set of WYE-connected three-phase stator windings having a first neutral point and a second set of WYE-connected three-phase stator windings having a second neutral point, the AC electric motor further comprising a switchable contact interposed between the first neutral point and the second neutral point;
a rechargeable source of stored electrical energy;
an inverter coupled to the rechargeable source of stored electrical energy and to the AC electric motor; and
one or more controllers collectively programmed with the following instructions:
cause the switchable contact to be open and switch the inverter to provide alternating current propulsive energy from the rechargeable source of stored electrical energy to the plurality of stator windings; and
cause the switchable contact to be closed and, using at least one of the stator windings as a boost inductor, switch the inverter to step up a voltage at a charging input coupled to the inverter to charge the rechargeable source of stored electrical energy.

18. The motor vehicle of claim 17, wherein:
the charging input is switchably coupled to the inverter by a second switchable contact; and
the one or more controllers are further collectively programmed with the following instruction:
cause the second switchable contact to be closed while the inverter is switched to step up a voltage at the charging input to charge the rechargeable source of stored electrical energy.

19. The motor vehicle of claim 18, wherein the instruction to switch the inverter to step up a voltage at the charging input to charge the rechargeable source of electrical energy further comprises an instruction to perform two-phase interleaved step-up conversion.

20. The motor vehicle of claim 19, wherein the inverter is a two-level inverter.
